(19) United States
(12) Patent Application Publication
(10) Pub. No.: US 2025/0022210 A1
(43) Pub. Date: Jan. 16, 2025

(54) X-RAY DISSECTOGRAPHY

(71) Applicant: RENSSELAER POLYTECHNIC INSTITUTE, Troy, NY (US)

(72) Inventors: Ge Wang, Loudonville, NY (US); Chuang Niu, Troy, NY (US)

(73) Assignee: RENSSELAER POLYTECHNIC INSTITUTE, Troy, NY (US)

(21) Appl. No.: 18/714,185

(22) PCT Filed: Nov. 29, 2022
(86) PCT No.: PCT/US22/51161

§ 371 Date: May 29, 2024

Related U.S. Application Data
(60) Provisional application No. 63/283,894, filed on Nov. 29, 2021.
(60) Provisional application No. 63/428,184, filed on Nov. 28, 2022.

(51) Int. Cl. G06T 15/10; G06T 11/00; G06V 10/25; G06V 10/82

(52) U.S. Cl. CPC G06T 15/10; G06T 11/006; G06T 11/008; G06V 10/25; G06V 10/82; G06T 2210/41; G06V 2201/031

(57) ABSTRACT

In one embodiment, there is provided a dissectography module for dissecting a two-dimensional (2D) radiograph. The dissectography module includes an input module, an intermediate module, and an output module. The input module is configured to receive a number K of 2D input radiographs, and to generate at least one three-dimensional (3D) input feature set, and K 2D input feature sets based, at least in part, on the K 2D input radiographs. The intermediate module is configured to generate a 3D intermediate feature set based, at least in part, on the at least one 3D input feature set. The output module is configured to generate output image data based, at least in part, on the K 2D input feature sets, and the 3D intermediate feature set. Dissecting corresponds to extracting a region of interest from the 2D input radiographs while suppressing one or more other structure(s).

### CROSS REFERENCE TO RELATED APPLICATION(S)

This application claims the benefit of U.S. Provisional Application No. 63/283,894, filed Nov. 29, 2021, and U.S. Provisional Application No. 63/428,184, filed Nov. 28, 2022, which are incorporated by reference as if disclosed herein in their entireties.

### GOVERNMENT LICENSE RIGHTS

This invention was made with government support under award numbers CA237267, HL151561, and EB031102, all awarded by the National Institutes of Health (NIH). The government has certain rights in the invention.

### FIELD

The present disclosure relates to x-ray, in particular to, x-ray dissectography.

### BACKGROUND

X-ray imaging, a medical imaging technique, may be performed by a variety of imaging systems. At a relatively low-end, x-ray radiography captures a two-dimensional (2D) projective image through a patient. The 2D projective image is termed a “radiogram” or a “radiograph”. In some situations, the 2D projective image may correspond to a 2D “scout” view, also known as, a topogram or planning radiograph, related to computed tomography (CT) scan planning. At a relatively high end, in computed tomography (CT) a relatively high number of x-ray projections are captured and then reconstructed into tomographic images transversely or volumetrically, providing three-dimensional (3D) imaging. Between these two ends, in digital tomosynthesis, a limited number of projections are captured over a relatively short scanning trajectory from which, 3D features inside a patient may be inferred.

Each x-ray imaging mode has respective strengths and weaknesses. For example, x-ray radiography is cost-effective but it produces a single projection that typically has a plurality of organs and tissues superimposed along x-ray paths. The superimposed organs and tissues can make interpreting a radiogram challenging, thus compromising the diagnostic performance. In another example, CT produces three-dimensional images that facilitate separating overlapping organs and tissues but subjects a patient to a much higher radiation dose compared to x-ray radiography, and is relatively complicated and expensive. Digital tomosynthesis (i.e., creating a 3D image from 2D x-ray images) may provide a balance between x-ray radiography and CT in terms of the number of needed projections, the information in resultant images, and the cost to build and operate the imaging system.

Development of x-ray imaging technologies is targeted to reducing radiation dose and improving imaging quality and speed. Currently x-ray radiography has a relatively low radiation dose, a relatively fast imaging speed, and a relatively low cost, compared to CT. Improving radiogram quality may thus be beneficial. Radiogram quality may be improved by suppressing interfering structures or enhancing related structures, and/or by generating 3D volumes, and thus facilitating separating overlapping or interfering structures.

### SUMMARY

In some embodiments, there is provided a dissectography module for dissecting a two-dimensional (2D) radiograph. The dissectography module includes an input module, an intermediate module, and an output module. The input module is configured to receive a number K of 2D input radiographs, and to generate at least one three-dimensional (3D) input feature set, and K 2D input feature sets based, at least in part, on the K 2D input radiographs. The intermediate module is configured to generate a 3D intermediate feature set based, at least in part, on the at least one 3D input feature set. The output module is configured to generate output image data based, at least in part, on the K 2D input feature sets, and the 3D intermediate feature set. Dissecting corresponds to extracting a region of interest from the 2D input radiographs while suppressing one or more other structure(s). In some embodiments of the dissectography module, the input module, the intermediate module and the output module each include an artificial neural network (ANN).

In some embodiments of the dissectography module, the input module includes K input 2D artificial neural networks (ANNs), and the output module includes K output 2D ANNs. Each input 2D ANN is configured to receive a respective 2D input radiograph and to generate a respective 2D input feature set. Each output 2D ANN is configured to receive a respective 2D intermediate feature set and to generate a respective dissected view.

In some embodiments of the dissectography module, the intermediate module includes a 3D ANN configured to generate the 3D intermediate feature set.

In some embodiments of the dissectography module, the number K is equal to two, and the output image data corresponds to two dissected radiographs configured to be provided to a left and a right eye through a pair of 3D glasses for stereoscopy.

In some embodiments of the dissectography module, the input module corresponds to a back projection module. The intermediate module corresponds to a 3D fusion module. The output module corresponds to a projection module.

In some embodiments of the dissectography module, each ANN is a convolutional neural network.

In some embodiments, there is provided a method for dissecting a two-dimensional (2D) radiograph. The method includes receiving, by an input module, a number K of 2D input radiographs; generating, by the input module, at least one three-dimensional (3D) input feature set, and K 2D input feature sets based, at least in part, on the K 2D input radiographs. The method further includes generating, by an intermediate module, a 3D intermediate feature set based, at least in part, on the at least one 3D input feature set; and generating, by an output module, output image data based, at least in part, on the K 2D input feature sets, and the 3D intermediate feature set. Dissecting corresponds to extracting a region of interest from the 2D input radiographs while suppressing one or more other structure(s).

In some embodiments of the method, the input module, the intermediate module and the output module each include an artificial neural network (ANN).

In some embodiments of the method, the input module includes K input 2D artificial neural networks (ANNs), and the output module includes K output 2D ANNs. The method further includes receiving, by each input 2D ANN, a respective 2D input radiograph, generating, by each input 2D ANN, a respective 2D input feature set, receiving, by each output 2D ANN, a respective 2D intermediate feature set, and generating, by each output 2D ANN, a respective dissected view.

In some embodiments of the method, the intermediate module includes a 3D ANN. The method further includes generating, by the 3D ANN, the 3D intermediate feature set.

In some embodiments of the method, the number K is equal to two, and the output image data corresponds to two dissected radiographs configured to be provided to a left and a right eye through a pair of 3D glasses for stereoscopy.

In some embodiments of the method, the input module corresponds to a back projection module, the intermediate module corresponds to a 3D fusion module and the output module corresponds to a projection module.

In some embodiments, there is provided dissectography system for dissecting a two-dimensional (2D) radiograph. The dissectography system includes a computing device, and a dissectography module. The computing device includes a processor, a memory, an input/output circuitry, and a data store. The dissectography module includes an input module, an intermediate module, and an output module. The input module is configured to receive a number K of 2D input radiographs, and to generate at least one three-dimensional (3D) input feature set, and K 2D input feature sets based, at least in part, on the K 2D input radiographs. The intermediate module is configured to generate a 3D intermediate feature set based, at least in part, on the at least one 3D input feature set. The output module is configured to generate output image data based, at least in part, on the K 2D input feature sets, and the 3D intermediate feature set. Dissecting corresponds to extracting a region of interest from the 2D input radiographs while suppressing one or more other structure(s).

In some embodiments of the dissectography system, the input module, the intermediate module and the output module each include an artificial neural network (ANN).

In some embodiments of the dissectography system, the input module includes K input 2D artificial neural networks (ANNs), and the output module includes K output 2D ANNs. Each input 2D ANN is configured to receive a respective 2D input radiograph and to generate a respective 2D input feature set. Each output 2D ANN is configured to receive a respective 2D intermediate feature set and to generate a respective dissected view.

In some embodiments of the dissectography system, the intermediate module includes a 3D ANN configured to generate the 3D intermediate feature set.

In some embodiments of the dissectography system, the number K is equal to two, and the output image data corresponds to two dissected radiographs configured to be provided to a left and a right eye through a pair of 3D glasses for stereoscopy.

In some embodiments of the dissectography system, the input module corresponds to a back projection module. The intermediate module corresponds to a 3D fusion module. The output module corresponds to a projection module.

In some embodiments of the dissectography system, each ANN is a convolutional neural network.

In some embodiments, there is provided a computer readable storage device. The device has stored thereon instructions that when executed by one or more processors result in the following operations including any embodiment of the method.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 illustrates a functional block diagram of a dissectography system that includes a dissectography module for electronically dissecting two-dimensional images, according to several embodiments of the present disclosure;

FIGS. 2A through 2C are functional block diagrams of example elements according to an embodiment of the dissectography module of FIG. 1;

FIGS. 3A through 3C are functional block diagrams of example elements according to another embodiment of the dissectography module of FIG. 1;

FIG. 4 is a functional block diagram of a portion of a collaborative detection system that includes an example output module according to another embodiment of the dissectography module of FIG. 1;

FIG. 5 is a flowchart of operations for training a dissectography system, according to various embodiments of the present disclosure; and

FIG. 6 is a flowchart of operations for electronically dissecting two-dimensional images, according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to x-ray dissectography (“XDT”). As used herein, x-ray dissectography means electronically dissecting a two-dimensional (2D) image to extract a region, organ and/or tissue of interest and/or suppress other structure(s). In an embodiment, the 2D image may correspond to a 2D input radiogram (i.e., radiograph). A 2D input radiograph may include, but is not limited to, a chest x-ray radiogram, a CT topographic scan, a cone-beam x-ray projection, etc. An apparatus, method, and/or system may be configured to receive a plurality of 2D input x-ray images corresponding to a plurality of views of a region of interest. Each of the plurality of 2D input x-ray images may contain the region of interest. In at least some of the 2D input x-ray images, a view of the region of interest may be blocked by other structure(s). The apparatus, method, and/or system may be configured to electronically dissect the plurality of 2D input x-ray images to remove or suppress the other structure(s). The apparatus, method, and/or system may then be configured to produce a 2D radiogram (i.e., output image data) with an enhanced view of the region or organ of interest, i.e., with interference from other structure(s) removed or suppressed.

In an embodiment, the apparatus, method, and/or system may be configured to receive a number K of 2D input radiographs. For example, the number K may be on the order of 1's, i.e., in the range of 1 to 9, e.g., two. In another example, the number K may be on the order of 10's, i.e., in the range of 10 to 99. In another example, K may be on the order of 100's, i.e., in the range of 100 to 999. In another example, K may be greater than or equal to 1000.

Thus, an apparatus, method, and/or system, according to the present disclosure, may enhance effectiveness of evaluating 2D x-ray images in support of the detection and diagnosis of disease.

By way of theoretical background, a conventional radiogram may be modeled as: x=Σᵢ₌₁^{B}yᵢ+yₜ, where x is the conventional radiogram, yₜ is a projection of a region of interest (e.g., organ), and Σᵢ₌₁^{B}yᵢ represents a superimposed image of a number, B, of anatomical components (e.g., other structures), included in the conventional radiogram. It may be appreciated that extracting the region of interest from only the conventional radiogram (i.e., solving for yₜ from x) is an ill-posed problem. It may be further appreciated that a specific organ in the human body has a fixed relative location, thus providing a relatively strong prior on material composition, and similar patterns (such as shapes, textures, and other properties). Based on such prior knowledge, a skilled radiologist can identify different organs in a conventional radiogram. Superimposed structures can challenge identification of a target organ by the skilled radiologist.

Generally, x-ray dissectography (XDT) may be configured to digitally extract a target region of interest (e.g., a target organ, or target tissue) from an original radiograph (or radiogram), that may contain superimposed organs/tissues. In an embodiment, the extraction may include deep learning. Extracting the target organ may then facilitate visual inspection and/or quantitative analysis. Considering that radiographs from different views contain complementary information, a physics-based XDT network, according to the present disclosure, may be configured to extract a plurality of multi-view features and transform the extracted features into a 3D space. The target region of interest may then be synergistically analyzed in isolation, and from different projection angles.

In one nonlimiting example, an XDT system, according to the present disclosure, may be configured to implement x-ray stereography, and may then be configured to improve image quality and diagnostic performance. X-ray stereography may allow a reader to immersively perceive the target region of interest from two dissected radiographs in 3D. It may be appreciated that x-ray stereography, according to the present disclosure, is configured to synergize machine intelligence and human intelligence. Biologically, stereo perception is based on binocular vision for the brain to reconstruct a 3D scene. Stereo perception can be applied to see through dissected radiograms and form a 3D rendering in a radiologist in their mind. It may be further appreciated that different from typical binocular visual information processing, which senses surroundings with reflected light signals, radiograms are projective through an object to allow a 3D conception of x-ray semi-transparent features.

It may be appreciated that deep learning relies on training an artificial neural network (ANN). As used herein, “neural network” (NN) and “artificial neural network” (ANN) are used interchangeably. Each ANN may include, but is not limited to, a deep NN (DNN), a convolutional neural network (CNN), a deep CNN (DCNN), a multilayer perceptron (MLP), etc. Training may be supervised, semi-supervised or unsupervised. Supervised (and semi-supervised) training utilizes training data that includes input data (e.g., conventional radiograph), and corresponding target output data (e.g., dissected radiograph). Training generally corresponds to “optimizing” the ANN, according some a defined metric, e.g., minimizing a loss function. An XDT neural network, according to the present disclosure, may thus be trained in a supervised 2D-to-2D learning fashion.

It may be appreciated that it is typically not feasible to obtain ground truth radiographs of a segmented region of interest for a living patient. In an embodiment, dissected radiograph image data may be generated using relatively widely available CT volumes. In one nonlimiting example, dissected 2D radiographs may be reconstructed from a sufficient number of radiograms corresponding to a number of different projection angles of the CT volume image data. To obtain a 2D radiograph of a target organ without surrounding tissues, the target organ may first be manually or automatically segmented in the associated CT volume. The ground truth radiograph may then be generated by projecting the dissected organ according to the system parameters. In other words, radiographs and CT images may be obtained from the same patient and the same imaging system, thus avoiding unpaired learning. In practice, paired 2D radiographs and CT volumes may be relatively easily obtained on a CT system since cone-beam projections may correspond to 2D radiographs.

Additionally or alternatively, training data and/or images may be collected using other systems e.g., a twin robotic x-ray system. Additionally or alternatively, training data and/or images may be generated using numerical simulation tools (e.g., academic or industrial), and/or digital phantoms, for training XDT networks. The simulators may utilize a clinical CT volume or a digital 3D phantom to compute a conventional x-ray radiograph, and then extract a target organ/tissue digitally, thus producing a ground truth radiograph of the target organ/tissue. Additionally or alternatively, domain adaption techniques may be utilized to optimize the performance of an XDT network, according to the present disclosure, by integrating both simulated and actual datasets. It is contemplated that an apparatus, method, and/or system, according to the present disclosure, may improve diagnostic performance in, for example, lung cancer screening, COVID-19 follow-up, as well as other applications.

Thus, an apparatus, method, and/or system, according to the present disclosure, may enhance effectiveness of evaluating 2D x-ray images in support of the detection and diagnosis of disease.

In one embodiment, there is provided a dissectography module for dissecting a two-dimensional (2D) radiograph. The dissectography module includes an input module, an intermediate module, and an output module. The input module is configured to receive a number K of 2D input radiographs, and to generate at least one three-dimensional (3D) input feature set, and K 2D input feature sets based, at least in part, on the K 2D input radiographs. The intermediate module is configured to generate a 3D intermediate feature set based, at least in part, on the at least one 3D input feature set. The output module is configured to generate output image data based, at least in part, on the K 2D input feature sets, and the 3D intermediate feature set. Dissecting corresponds to extracting a region of interest from the 2D input radiographs while suppressing one or more other structure(s).

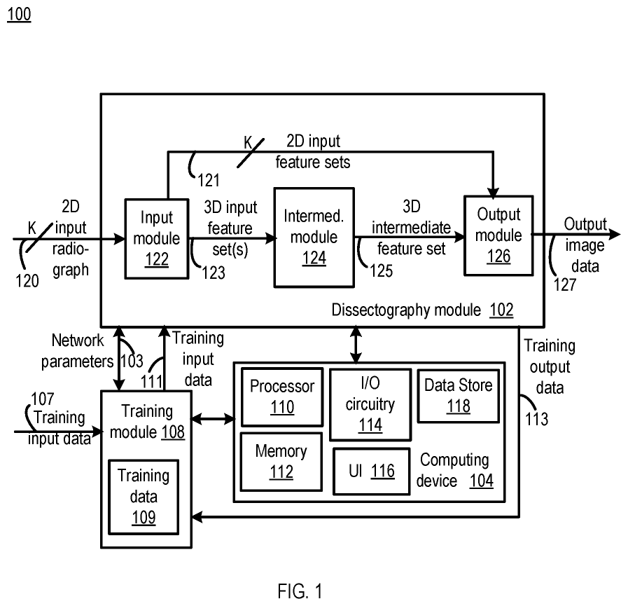

FIG. 1 illustrates a functional block diagram of a dissectography system 100 that includes a dissectography module 102 for electronically dissecting two-dimensional images, according to several embodiments of the present disclosure. Dissectography system 100 includes the dissectography module 102, a computing device 104, and may include a training module 108. Dissectography module 102 and/or training module 108 may be coupled to or included in computing device 104. The dissectography module 102 is configured to receive a number K of two-dimensional (2D) input radiographs 120 and to provide output image data 127, as will be described in more detail below. The 2D input radiographs may correspond to 2D x-ray projections, radiographs, radiograms, and/or topograms (i.e., planning radiographs). The output image data may correspond to dissected 2D radiograph data, e.g., image data corresponding to K dissected views.

Computing device 104 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Computing device 104 includes a processor 110, a memory 112, input/output (I/O) circuitry 114, a user interface (UI) 116, and data store 118.

Processor 110 is configured to perform operations of dissectography module 102 and/or training module 108. Memory 112 may be configured to store data associated with dissectography module 102 and/or training module 108. I/O circuitry 114 may be configured to provide wired and/or wireless communication functionality for dissectography system 100. For example, I/O circuitry 114 may be configured to receive K 2D input radiographs 120 and/or training input data 107 and to provide output image data 127. UI 116 may include a user input device (e.g., keyboard, mouse, microphone, touch sensitive display, etc.) and/or a user output device, e.g., a display. Data store 118 may be configured to store one or more of training input data 107, K 2D input radiographs 120, output image data 127, network parameters, and/or data associated with dissectography module 102 and/or training module 108.

Training module 108 may be configured to receive training input data 107. Training module 108 may be further configured to generate training data 109 and/or to store training input data in training data 109. Training input data 107 may include, for example, a plurality of training data pairs that include 2D input radiographs and corresponding target dissected 2D radiographs, that may then be stored in training data 109. In another example, training data 107 may include 3D CT volume image data, that may then be segmented to yield ground truth 2D radiographs corresponding to training 2D input radiographs, as described herein.

The dissectography module 102 may then be trained prior to operation. Generally, training operations include providing training input data 111 to dissectography module 102, capturing training output data 113 corresponding to output image data from dissectography module 102, evaluating a cost function, and adjusting network parameters 103 to optimize the network parameters 103. In one nonlimiting example, optimizing may correspond to minimizing the cost function. The network parameters 103 may be related to one or more of input module 122, intermediate module 124, and/or output module 126, as will be described in more detail below. Training operations may repeat until a stop criterion is met, e.g., a cost function threshold value is achieved, a maximum number of iterations has been reached, etc. At the end of training, network parameters 103 may be set for operation. The dissectography module 102 may then be configured to provide a respective dissected view for each 2D input radiograph, as output image data 127.

During operation (and/or training), the dissectography module 102 is configured to receive a number K of 2D input radiographs 120 and to provide, as output, output image data 127. Each input radiograph of the number K of 2D input radiographs 120 may correspond to a respective view. Thus, the K 2D input radiographs 120 may include as many as K views of a region of interest and/or organ that is to be electronically dissected.

Dissectography module 102 includes an input module 122, an intermediate module 124, and an output module 126. The input module 122, the intermediate module 124, and the output module 126 are coupled in series. The input module 122 is configured to receive the K 2D input radiographs 120 as input, to extract K 2D input feature sets 121, and to generate one or more 3D input feature set(s) 123. The input module 122 is further configured to provide, the K 2D input feature sets 121, and the 3D input feature set(s) 123, as output. The intermediate module 124 is configured to receive the 3D input feature set(s) 123 and to generate a 3D intermediate feature set 125. The intermediate module 124 is configured to provide as output the 3D intermediate feature set 125. The output module 126 is configured to receive the 3D intermediate feature set 125 and the K 2D input feature sets 121. The output module 126 is then configured to generate output image data 127 based, at least in part, on the 3D intermediate feature set 125 and, based, at least in part, on the K 2D input feature sets 121. The output module 126 is configured to provide the output image data 127, as output. In one nonlimiting example, the output image data 127 may correspond to the number K electronically dissected views of the region of interest, as described herein. In another nonlimiting example, the output image data 127 may correspond to 2D and/or 3D predicted objects, as will be described in more detail below.

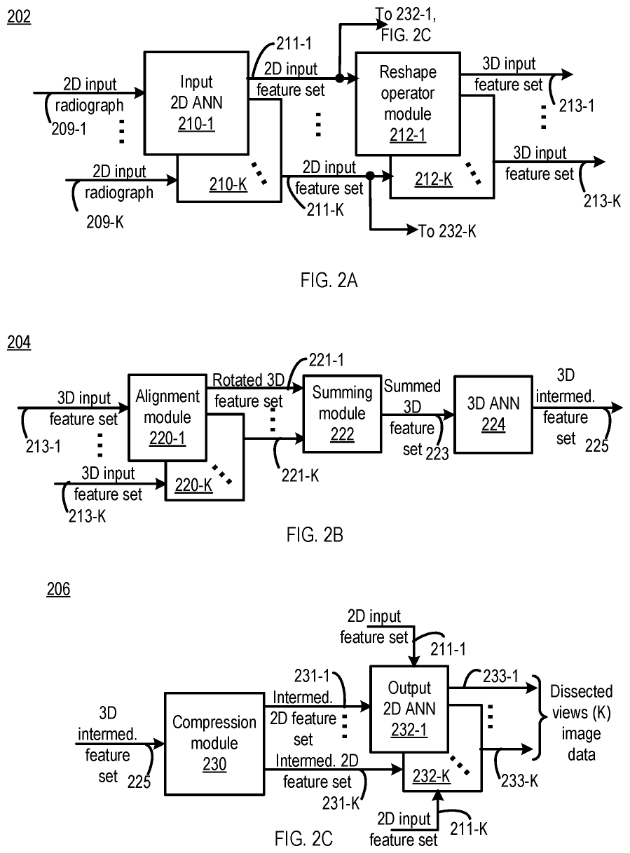

FIGS. 2A through 2C are functional block diagrams 202, 204, and 206, respectively, of example elements according to an embodiment of the dissectography module 102 of FIG. 1. FIGS. 2A through 2C may be best understood when considered together. FIG. 2A is one example of input module 122, FIG. 2B is one example of the intermediate module 124, and FIG. 2C is one example of output module 126, all of FIG. 1. In this embodiment, the corresponding dissectography module is configured to generate the number K of dissected views corresponding to the number K 2D input radiographs.

Turning first to FIG. 2A, the example input module 202 includes a plurality, e.g., the number K of input 2D artificial neural networks (ANNs) 210-1, . . . , 210-K, and the number K of reshape operator modules 212-1, . . . , 212-K. In one nonlimiting example, each input 2D ANN 210-1, . . . , 210-K may correspond to a convolutional neural network (CNN). Each input 2D ANN 210-1, . . . , 210-K may have a same architecture with trainable parameters (i.e., network parameters). In some embodiments, the trainable parameters may be optimized similarly. In some embodiments, the trainable parameters may be optimized differently.

Each input 2D ANN 210-1, . . . , 210-K is configured to receive a respective 2D input radiograph (i.e., view) 209-1, . . . , 209-K, and to generate, i.e., extract, a respective 2D input feature set 211-1, . . . , 211-K. Each reshape operator module 212-1, . . . , 212-K is configured to receive a respective 2D input feature set 211-1, . . . , 211-K, and to generate a respective 3D input feature set 213-1, . . . , 213-K. Each respective 2D input feature set 211-1, . . . , 211-K may be provided to a respective output 2D ANN 232-1, . . . , 232-K, included in the example output module 206 of FIG. 2C, as will be described in more detail below.

It may be appreciated that, in this example, input module 202 may correspond to a back projection module. In other words, input module 202 is configured to map to 2D radiographs to 3D features, similar to a tomographic back projection process.

Turning now to FIG. 2B, the example intermediate module 204 is configured to receive the number K of 3D input feature sets 213-1, . . . , 213-K, from, e.g., input module 202, and to generate a 3D intermediate feature set 225, as output. The example intermediate module 204 includes the number K of alignment modules 220-1, . . . , 220-K, a summing module 222, and a 3D ANN 224. Each alignment module 220-1, . . . , 220-K is configured to receive a respective 3D input feature set 213-1, . . . , 213-K. Each alignment module 220-1, . . . , 220-K is configured to align 3D features of each view, by rotation according to a respective projection angle, to generate a respective rotated 3D feature set 221-1, . . . , 221-K. The summing module 222 is configured to receive the K rotated 3D feature sets 221-1, . . . , 221-K and may then be configured to sum respective 3D features of each view for each projection angle to yield a summed 3D feature set 223. The 3D ANN 224 may then be configured to refine, i.e. combine, the summed 3D feature set 223 to yield to the 3D intermediate feature set 225. It may be appreciated that, in this example, intermediate module 204 may correspond to a fusion module, configured to integrate information from the K views in a 3D feature space.

Turning now to FIG. 2C, the example output module 206 is configured to receive the 3D intermediate feature set 225 from, for example, intermediate module 204, and to generate the number K of dissected views image data 233-1, . . . , 233-K. The example output module 206 includes a compression module 230, and the number K output 2D ANNs 232-1, . . . , 232-K. The compression module 230 is configured to receive the 3D intermediate feature set 225 and to generate the number K intermediate 2D feature sets 231-1, . . . , 231-K. The compression module 230 may be configured to compress each 3D feature volume, included in the 3D intermediate feature set 225, into a respective 2D feature map along a respective angle. Each output 2D ANN 232-1, . . . , 232-K, is configured to receive a respective intermediate 2D feature set 231-1, . . . , 231-K, and a respective 2D input feature set 211-1, . . . , 211-K, and to generate a respective dissected view image data 233-1, . . . , 233-K. Thus, output module 206 may correspond to a projection module, configured to receive the 3D intermediate feature set 225, and the number K 2D input feature sets 211-1, . . . , 211-K. The output module 206 may then be configured to predict the number K dissected views 233-1, . . . , 233-K, i.e., radiographs, of the target organ and/or region of interest, without other structures. Each dissected views 233-1, . . . , 233-K is configured to correspond to a respective 2D input radiograph 209-1, . . . , 209-K.

In one nonlimiting example, dissectography system 100 and/or example dissectography module elements 202, 204, and 206, may be configured to provide x-ray stereography (i.e., stereography). As is known, humans perceive the world in 3D thanks to binocular vision. Based, at least in part, on a binocular disparity, a human brain may sense a depth in a scene. X-ray stereography (XST) is configured to rely on such binocular vision to provide a radiologist, for example, with a 3D stereoscopic view of an isolated organ (or dissected region of interest) using two selected radiograms that include images of the isolated organ. It may be appreciated that, when inspecting a human body with x-rays (i.e., with radiograms), organs/tissues with relatively large linear attenuation coefficients may overwhelm organs/tissues with relatively small attenuation coefficients. Due to superimposition of a plurality of organs/tissues in 2D radiographs, discerning relatively subtle changes in internal organs/tissues may be difficult, significantly compromising stereopsis. An apparatus, system and/or method, according to the present disclosure, may be configured to integrate machine intelligence for target organ dissection and human intelligence for stereographic perception. A radiologist may then perceive a target organ in 3D with details relatively more vivid than in 2D, potentially improving diagnostic performance.

In an embodiment, dissectography system 100 and/or example dissectography module elements 202, 204, and 206 may be configured to implement XST of a selected organ with the number K equal to two, corresponding to two eyes. Thus, the input module 202 may be configured to receive two radiographs 209-1, 209-K (K=2) as inputs, corresponding to a respective image for each eye. The intermediate module 204 may be configured to use a selected rotation center to align 3D features from two branches appropriately, corresponding to the view angles of two eyes. The output module may be configured to translate a merged 3D feature and then compress the 3D feature to 2D feature maps according to the human reader's viewing angles. The two dissected radiographs may then be respectively provided to the left and right eyes through a pair of 3D glasses for stereoscopy.

An adequately trained dissectography system 100, as described herein, may be configured to reconstruct image volumes using radiographs from sufficiently many different angles. In one nonlimiting example, a cone-beam CT system may be used for this purpose. A relatively large number of pairs of conventional radiographs and corresponding target-only (i.e., dissected view) radiographs may be obtained from a reconstructed CT volume and a segmented organ in the reconstructed CT volume, respectively. To achieve x-ray stereopsis, each source of a model CT system may be regarded as an eye, and a projection through the body may be recorded on an opposing detector. In one example, two radiograms may be captured from the XDT system so that a distance between two x-ray source locations corresponds to a distance between two eyes, d. In this case, a center of X-ray beams relative to the source positions may intersect at a center of an imaging object. In another example, for adaption to different applications and readers, an adjustable XST system may be implemented. An adjustable XST system may be configured with an adjustable offset between the two eyes and an adjustable viewing angle relative to a defined principal direction. It may be appreciated that the adjustable offset between the two eyes and the adjustable viewing angle relative to a defined principal direction may be related to two parameters of the XST. Given a distance between two eyes, d, a distance between an x-ray source and an imaging object center, r, and an angle between a center x-ray and the defined principal (i.e., reference) direction, a, for both eyes, an intersection point of two center x-rays may be translated from the object center along a vertical direction. The distance offset δ may then be determined as:

$$δ = \frac{d}{2 tan α} - \sqrt{{r}^{2} - {( d / 2 )}^{2}}$$

The distance offset δ may then be used to adjust a rotation center for XST-Net.

It may be appreciated that different geometric parameters of the XST system may be utilized for inspecting different organs/tissues. Both XDT and XST systems can be implemented in various ways such as with robotic arms so that the geometric parameters may be set to match a reader's preference.

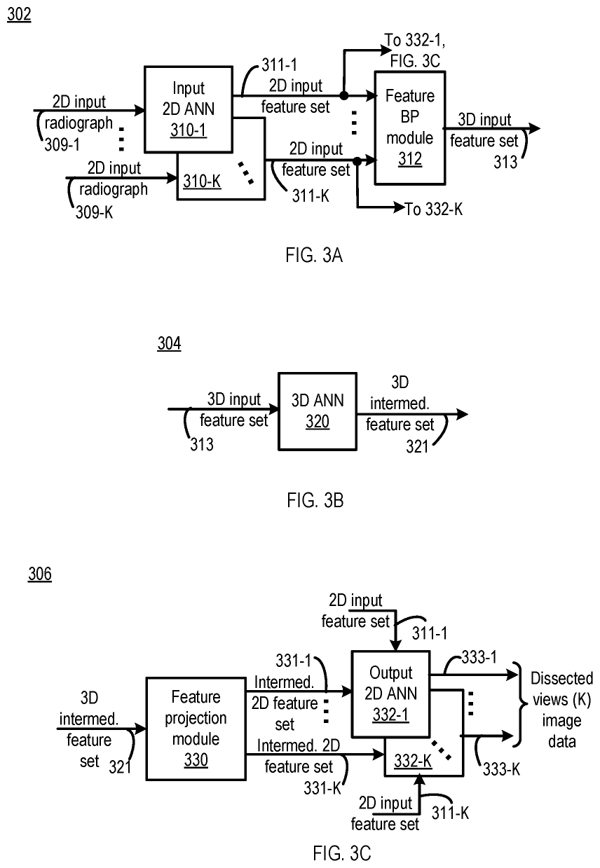

FIGS. 3A through 3C are functional block diagrams 302, 304, and 306, respectively, of example elements according to another embodiment of the dissectography module 102 of FIG. 1. FIGS. 3A through 3C may be best understood when considered together. FIG. 3A is one example of input module 122, FIG. 3B is one example of the intermediate module 124, and FIG. 3C is one example of output module 126, all of FIG. 1. In this embodiment, the corresponding dissectography module is configured to generate the number K of dissected views corresponding to the number K 2D input radiographs.

Turning first to FIG. 3A, the example input module 302 includes a plurality, e.g., the number K of input 2D ANNs 310-1, . . . , 310-K, and feature back projection (BP) module 312. Each input 2D ANN 310-1, . . . , 310-K may have a same architecture with trainable parameters (i.e., network parameters). In some embodiments, the trainable parameters may be optimized similarly. In some embodiments, the trainable parameters may be optimized differently. In one nonlimiting example, the input 2D ANNs 310-1, . . . , 310-K may share weights.

Each input 2D ANN 310-1, . . . , 310-K is configured to receive a respective 2D input radiograph 309-1, . . . , 309-K, and to generate, i.e., extract, a respective 2D input feature set 311-1, . . . , 311-K. The feature BP module 312 is configured to receive the number K 2D input feature sets 311-1, . . . , 311-K, and to generate a 3D input feature set 313. Each respective 2D input feature set 311-1, . . . , 311-K may be provided to a respective output 2D ANN 332-1, . . . , 332-K, included in the example output module 306 of FIG. 3C, as will be described in more detail below.

It may be appreciated that a selected 2D feature (i.e., “channel”) of each 2D input feature set 311-1, . . . , 311-K may be regarded as a projection of a corresponding selected 3D feature from each of the number K views. As used herein, a number of channels, included in each feature set is M. A 3D volume may be independently reconstructed for each selected feature through a 3D reconstruction layer. In one nonlimiting example, the 3D reconstruction layer may be implemented as a back-projection (BP) operation using a same imaging parameters. The feature BP module 312 is configured to reconstruct a respective 3D feature corresponding to each channel of the K 2D input feature sets 311-1, . . . , 311-K. The 3D input feature set 313 may thus include the number M 3D features corresponding to the M 2D features of each 2D input feature set. In one nonlimiting example, the features of the 2D input feature sets and the 3D input feature set may have respective spatial resolutions of 16×16 (2D input feature sets) and 16×16×16 (3D input feature set) and may have on the order of tens of projections. Thus, alignment of 2D features with 3D features may be facilitated.

In this example, input module 302 may correspond to a 2D feature encoder and a feature back projection layer. Input module 302 is configured to map to 2D radiographs to a 3D feature set, similar to a tomographic back projection process.

Turning now to FIG. 3B, the example intermediate module 304 is configured to receive the 3D input feature set 313, from, e.g., input module 302, and to generate a 3D intermediate feature set 321, as output. The example intermediate module 304 includes a 3D ANN 320. The 3D ANN 320 is configured to receive the 3D input feature set 313, to analyze the 3D input feature set (i.e., the M channels), and to generate the 3D intermediate feature set 321. It may be appreciated that, in this example, intermediate module 304 may correspond to a 3D feature transformation layer.

Turning now to FIG. 3C, the example output module 306 is configured to receive the 3D intermediate feature set 321 from, for example, intermediate module 304, and to generate the number K of dissected views image data 333-1, . . . , 333-K. The example output module 306 includes a feature projection module 330, and the number K output 2D ANNs 332-1, . . . , 332-K. The feature projection module 330 is configured to receive the 3D intermediate feature set 321 and to generate the number K intermediate 2D feature sets 331-1, . . . , 331-K. The feature projection module 330 may be configured to project each 3D feature (i.e., channel) of all views, included in the 3D intermediate feature set 321, into a 2D feature space. It may be appreciated that projection, in this context, is a dual operation of the back projection operation. Each output 2D ANN 332-1, . . . , 332-K, is configured to receive a respective intermediate 2D feature set 331-1, . . . , 331-K, and a respective 2D input feature set 311-1, . . . , 311-K, and to generate a respective dissected view image data 333-1, . . . , 333-K. The output 2D ANNs 332-1, . . . , 332-K may thus correspond to 2D feature decoders, i.e., symmetric 2D feature decoder with skip connections from the 2D feature encoders 310-1, . . . , 310-K, and are configured to regress a final dissection result.

Thus, output module 306 may correspond to a projection module, configured to receive the 3D intermediate feature set, and the number K 2D input feature sets. The output module 306 may then be configured to predict the number K dissected views, i.e., radiographs, of the target organ and/or region of interest, without other structures, corresponding to the number K 2D input radiographs 309-1, . . . , 309-K.

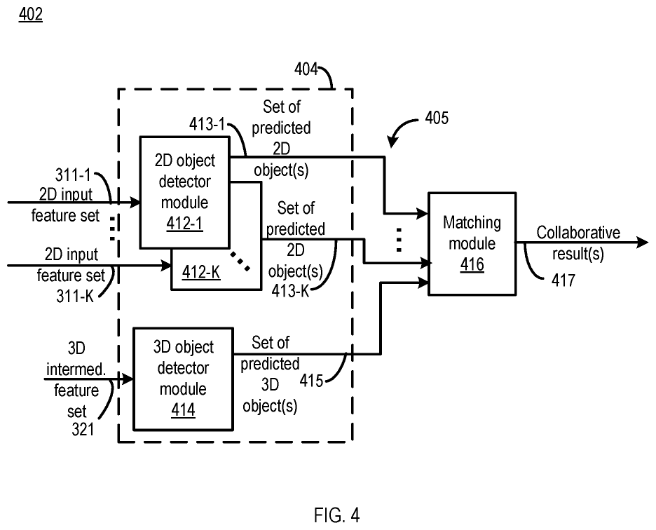

FIG. 4 is a functional block diagram 402 of a portion of a collaborative detection system that includes an example output module 404 according to another embodiment of the dissectography module 102 of FIG. 1. FIG. 4 may be best understood when considered with FIGS. 3A and 3B, as described herein. Example output module 404 is one example of output module 126 of FIG. 1. In one nonlimiting example, the collaborative detection system may be configured to detect lung nodules, based, at least in part, on a plurality of 2D radiographs. It is contemplated that a collaborative detection system, according to the present disclosure, may be configured to detect other objects in other regions of interest.

The example output module 404 is configured to receive the number K of 2D input feature sets 311-1, . . . , 311-K from, for example, input module 302, and the 3D intermediate feature set 321 from, for example, intermediate module 304. The example output module 404 is further configured to generate output image data 405. Output image data 405 may include the number K of sets of predicted 2D objects 413-1, . . . , 413-K, and a set of predicted 3D objects 415. The example output module 404 includes the number K 2D object detector modules 412-1, . . . , 412-K, and a 3D object detector module 414. Each 2D object detector module 412-1, . . . , 412-K, is configured to receive respective 2D input feature set 311-1, . . . , 311-K, and to generate a respective set of predicted 2D objects 413-1, . . . , 413-K. The 3D object detector module 414 is configured to receive the 3D intermediate feature set 321 and to generate the set of predicted 3D objects 415.

In one nonlimiting example, each 2D object detector module 412-1, . . . , 412-K may correspond to a two-stage Faster RCNN (region-based convolutional neural network) object detector. However, this disclosure is not limited in this regard. Other object detection neural networks may be implemented, within the scope of the present disclosure. In a first stage, a region proposal network (RPN) may be configured to generate a set of candidate bounding boxes (BBox) that may contain objects of interest. In a second stage, given the candidate BBoxes and the 2D features included in a respective 2D input feature set, a region of interest (RoI) align layer may be followed by a classification head and a box regression head configured to predict an object class (e.g., object present or object not found) and to refine the BBoxes, respectively. The 3D object detector module 414 corresponds to an extension of the 2D object detector. Each 2D component may be modified to a corresponding 3D component. The modified components may include a 3D anchor, a 3D RoI align layer, 3D classification and regression heads, and corresponding loss functions.

The collaborative detection system 402 further includes a matching module 416. Matching module 416 is configured to receive output image data 405, and to generate one or more collaborative result(s) 417. In one nonlimiting example, the collaborative result(s) 417 may correspond to the detection of lung nodules. However, this disclosure is not limited in this regard.

In one embodiment, the matching module 416 is configured to implement a collaborative matching technique, without hyper-parameters. The collaborative matching technique is configured to collaboratively integrate the 2D and 3D predictions, i.e., output image data 405, from the output module 404. It may be appreciated that an object missed in one projection may be detected in another projection, and a relatively strongly positive object found in most projection may be relatively easily detected in the integrated 3D space.

Thus, a collaborative detection system, according to the present disclosure, may be configured to detect lung nodules or other objects, based, at least in part, on a plurality of 2D radiographs.

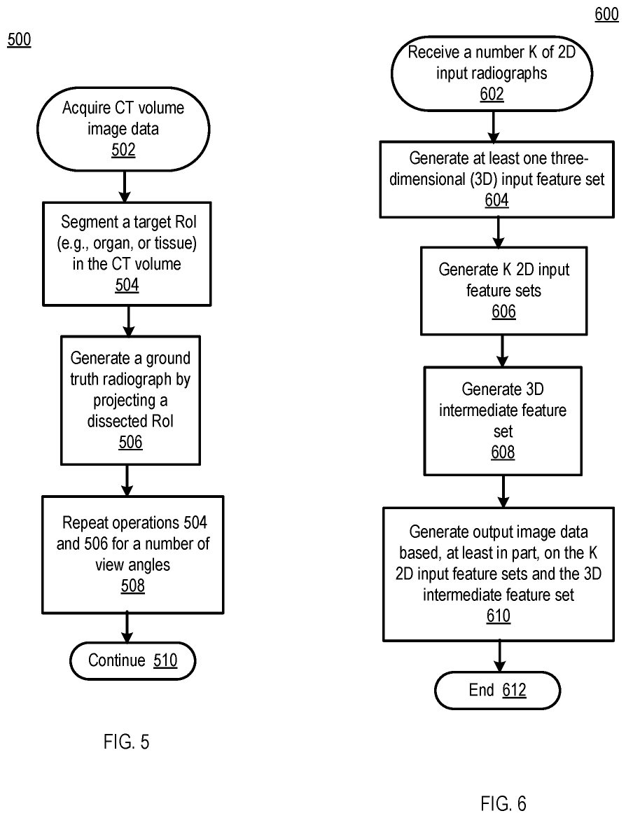

FIG. 5 is a flowchart 500 of operations for training a dissectography system, according to an embodiment of the present disclosure. In particular, the flowchart 500 illustrates training a dissectography module. The operations may be performed, for example, by the dissectography system 100 (e.g., dissectography module 102, and/or training module 108) of FIG. 1.

Operations of this embodiment may begin with acquiring CT volume image data at operation 502. The CT volume image data may be actual or simulated. A target RoI (e.g., organ, or tissue) may be segmented in the CT volume at operation 504. A ground truth radiograph may be generated by projecting a dissected RoI at operation 506. Operations 504 and 506 may be repeated for a number of view angles at operation 508. Program flow may then continue at operation 510.

Thus, a dissectography module may be trained using actual or simulated 3D CT volume data.

FIG. 6 is a flowchart 600 of operations for electronically dissecting two-dimensional images, according to various embodiments of the present disclosure. In particular, the flowchart 600 illustrates electronically dissecting 2D input radiographs. The operations may be performed, for example, by the dissectography system 100 (e.g., dissectography module 102 and/or computing device 104) of FIG. 1.

Operations of this embodiment may begin with receiving a number K of 2D input radiographs at operation 602. At least one three-dimensional (3D) input feature set may be generated at operation 604. K 2D input feature sets may be generated at operation 606. K three-dimensional (3D) input feature sets and the K 2D input feature sets may be generated based, at least in part, on the K 2D input radiographs. A 3D intermediate feature set may be generated based, at least in part, on the K 3D input feature sets at operation 608. Output image data may be generated based, at least in part, on the K 2D input feature sets and the 3D intermediate feature set at operation 610. Dissecting corresponds to extracting a region of interest from the 2D input radiographs while suppressing one or more other structure(s). Program flow may then end at operation 612

Thus, electronically dissecting 2D input radiographs may be electronically dissected.

Generally, this disclosure relates to x-ray dissectography (“XDT”). An apparatus, method, and/or system may be configured to receive a plurality of 2D input x-ray images corresponding to a plurality of views of a region of interest. Each of the plurality of 2D input x-ray images may contain the region of interest. In at least some of the 2D input x-ray images, a view of the region of interest may be blocked by other structure(s). The apparatus, method, and/or system may be configured to electronically dissect the plurality of 2D input x-ray images to remove or suppress the other structure(s). The apparatus, method, and/or system may then be configured to produce a 2D radiogram (i.e., output image data) with an enhanced view of the region or organ of interest, i.e., with interference from other structure(s) removed or suppressed.

Thus, an apparatus, method, and/or system, according to the present disclosure, may enhance effectiveness of evaluating 2D x-ray images in support of the detection and diagnosis of disease.

As used in any embodiment herein, the terms “logic” and/or “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 112 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A dissectography module for dissecting a two-dimensional (2D) radiograph, the dissectography module comprising:
an input module configured to receive a number K of 2D input radiographs, and to generate at least one three-dimensional (3D) input feature set, and K 2D input feature sets based, at least in part, on the K 2D input radiographs;
an intermediate module configured to generate a 3D intermediate feature set based, at least in part, on the at least one 3D input feature set; and
an output module configured to generate output image data based, at least in part, on the K 2D input feature sets, and the 3D intermediate feature set,
wherein dissecting corresponds to extracting a region of interest from the 2D input radiographs while suppressing one or more other structure(s).

2. The dissectography module of claim 1, wherein the input module, the intermediate module and the output module each comprise an artificial neural network (ANN).

3. The dissectography module of claim 1, wherein the input module comprises K input 2D artificial neural networks (ANNs), and the output module comprises K output 2D ANNs, each input 2D ANN is configured to receive a respective 2D input radiograph and to generate a respective 2D input feature set, and each output 2D ANN is configured to receive a respective 2D intermediate feature set and to generate a respective dissected view.

4. The dissectography module of claim 1, wherein the intermediate module comprises a 3D ANN configured to generate the 3D intermediate feature set.

5. The dissectography module according to claim 1, wherein the number K is equal to two, and the output image data corresponds to two dissected radiographs configured to be provided to a left and a right eye through a pair of 3D glasses for stereoscopy.

6. The dissectography module according to claim 1, wherein the input module corresponds to a back projection module, the intermediate module corresponds to a 3D fusion module and the output module corresponds to a projection module.

7. The dissectography module of claim 2, wherein each ANN is a convolutional neural network.

8. A method for dissecting a two-dimensional (2D) radiograph, the method comprising:
receiving, by an input module, a number K of 2D input radiographs;
generating, by the input module, at least one three-dimensional (3D) input feature set, and K 2D input feature sets based, at least in part, on the K 2D input radiographs;
generating, by an intermediate module, a 3D intermediate feature set based, at least in part, on the at least one 3D input feature set; and
generating, by an output module, output image data based, at least in part, on the K 2D input feature sets, and the 3D intermediate feature set,
wherein dissecting corresponds to extracting a region of interest from the 2D input radiographs while suppressing one or more other structure(s).

9. The method of claim 8, wherein the input module, the intermediate module and the output module each comprise an artificial neural network (ANN).

10. The method of claim 8, wherein the input module comprises K input 2D artificial neural networks (ANNs), and the output module comprises K output 2D ANNs, further comprising receiving, by each input 2D ANN, a respective 2D input radiograph, generating, by each input 2D ANN, a respective 2D input feature set, receiving, by each output 2D ANN, a respective 2D intermediate feature set, and generating, by each output 2D ANN, a respective dissected view.

11. The method of claim 8, wherein the intermediate module comprises a 3D ANN, and further comprising generating, by the 3D ANN, the 3D intermediate feature set.

12. The method of claim 8, wherein the number K is equal to two, and the output image data corresponds to two dissected radiographs configured to be provided to a left and a right eye through a pair of 3D glasses for stereoscopy.

13. The method of claim 8, wherein the input module corresponds to a back projection module, the intermediate module corresponds to a 3D fusion module and the output module corresponds to a projection module.

14. A dissectography system for dissecting a two-dimensional (2D) radiograph, the dissectography system comprising:
a computing device comprising a processor, a memory, an input/output circuitry, and a data store; and
a dissectography module comprising:
an input module configured to receive a number K of 2D input radiographs, and to generate at least one three-dimensional (3D) input feature set, and K 2D input feature sets based, at least in part, on the K 2D input radiographs,
an intermediate module configured to generate a 3D intermediate feature set based, at least in part, on the at least one 3D input feature set, and
an output module configured to generate output image data based, at least in part, on the K 2D input feature sets, and the 3D intermediate feature set,
wherein dissecting corresponds to extracting a region of interest from the 2D input radiographs while suppressing one or more other structure(s).

15. The dissectography system of claim 14, wherein the input module, the intermediate module and the output module each comprise an artificial neural network (ANN).

16. The dissectography system of claim 14, wherein the input module comprises K input 2D artificial neural networks (ANNs), and the output module comprises K output 2D ANNs, each input 2D ANN is configured to receive a respective 2D input radiograph and to generate a respective 2D input feature set, and each output 2D ANN is configured to receive a respective 2D intermediate feature set and to generate a respective dissected view.

17. The dissectography system of claim 14, wherein the intermediate module comprises a 3D ANN configured to generate the 3D intermediate feature set.

18. The dissectography system according to claim 14, wherein the number K is equal to two, and the output image data corresponds to two dissected radiographs configured to be provided to a left and a right eye through a pair of 3D glasses for stereoscopy.

19. The dissectography system according to claim 14, wherein the input module corresponds to a back projection module, the intermediate module corresponds to a 3D fusion module and the output module corresponds to a projection module.

20. A computer readable storage device having stored thereon instructions that when executed by one or more processors result in the following operations comprising the method according to claim 8.
